(19) United States
(12) Patent Application Publication
(10) Pub. No.: US 2015/0083199 A1
(43) Pub. Date: Mar. 26, 2015

(54) PHOTOVOLTAIC POWER GENERATION SYSTEM

(71) Applicant: KABUSHIKI KAISHA TOSHIBA, Tokyo (JP)

(72) Inventors: Tomohiko JIMBO, Fujisawa (JP); Biswas DEBASISH, Shiki (JP); Kei MATSUOKA, Kawasaki (JP); Yoshiaki HASEGAWA, Tokyo (JP)

(21) Appl. No.: 14/490,025

(22) Filed: Sep. 18, 2014

(30) Foreign Application Priority Data
Sep. 20, 2013 (JP) 2013-196242

(51) Int. Cl. H02S 20/23

(52) U.S. Cl. CPC H02S 20/23
USPC 136/251

(57) ABSTRACT

According to an embodiment, a photovoltaic power generation system includes a photovoltaic array group and a windbreak. The photovoltaic array group includes a plurality of photovoltaic arrays, each of the photovoltaic arrays including a plurality of solar panels and a support structure which supports the solar panels. The windbreak is arranged behind the photovoltaic array group and includes a curved surface configured to guide at least some of a wind, which blows from a back side of the photovoltaic array group toward the photovoltaic array group, to an upper side of the photovoltaic array group.

### CROSS-REFERENCE TO RELATED APPLICATIONS

This application is based upon and claims the benefit of priority from Japanese Patent Application No. 2013-196242, filed Sep. 20, 2013, the entire contents of which are incorporated herein by reference.

### FIELD

Embodiments described herein relate generally to a photovoltaic power generation system.

### BACKGROUND

In recent years, concerns about environmental issues are boosting the global installation of photovoltaic power generation systems that generate power using sunlight, and mega solar power plants equipped with a large-scale photovoltaic power generation system have been constructed at locations throughout the world. In the photovoltaic power generation system, a number of solar panels are arranged. These solar panels are supported and fixed by a support structure including a rack and a base. The support structure is required to have a strength capable of withstanding wind pressure and the like acting on the solar panels.

However, the installation cost of support structures makes up a large proportion of the installation cost of a photovoltaic power generation system. This proportion is larger especially in a mega solar system in which 10,000 or more solar panels are arranged. It is therefore required to reduce the installation costs of the support structures. The reduction of the installation costs of support structures can be achieved by reducing the weight of the support structures. However, it is difficult to reduce the weight of the support structures while ensuring their ability to withstand wind pressure and the like.

It is desirable to be able to reduce the installation costs of support structures in a photovoltaic power generation system.

### BRIEF DESCRIPTION OF THE DRAWINGS

FIG. 1 is a side view showing a photovoltaic power generation system according to an embodiment;

FIG. 2 is a plan view showing the photovoltaic power generation system shown in FIG. 1;

FIG. 3A is a side view showing an example of the shape of a baffle plate shown in FIG. 1;

FIG. 3B is a side view showing another example of the shape of the baffle plate shown in FIG. 1;

FIG. 3C is a side view showing still another example of the shape of the baffle plate shown in FIG. 1;

FIG. 4 is a schematic view showing a state in which the flow of air is changed by a windbreak shown in FIG. 1;

FIG. 5 is a plan view showing a photovoltaic power generation system according to Comparative Example 1;

FIG. 6 is a plan view showing a photovoltaic power generation system according to Comparative Example 2;

FIGS. 7A and 7B are views showing an analytic model used in numerical analysis;

FIGS. BA and BB are views showing wind force coefficient distributions in a photovoltaic array group shown in FIG. 5 which are obtained by numerical analysis;

FIGS. 9A and 9B are views showing wind force coefficient distributions in a photovoltaic array group shown in FIG. 6 which are obtained by numerical analysis;

FIG. 10 is a plan view showing an example of setting a central region in the photovoltaic power generation system according to Comparative Example 1;

FIG. 11 is a plan view showing an example of setting a central region in the photovoltaic power generation system according to the embodiment;

FIGS. 12A, 12B, and 12C are views showing results of two-dimensional analysis of the windbreak effect of the windbreak;

FIGS. 13A, 13B, and 13C are side views showing examples in which the support structures of the windbreaks shown in FIGS. 3A, 3B, and 3C are provided with a tilting device; and

FIG. 14 is a side view showing an example of arranging the photovoltaic power generation system on a building according to the embodiment.

### DETAILED DESCRIPTION

In general, according to an embodiment, a photovoltaic power generation system includes a photovoltaic array group and a windbreak. The photovoltaic array group includes a plurality of photovoltaic arrays, each of the photovoltaic arrays including a plurality of solar panels and a support structure which supports the solar panels. The windbreak is arranged behind the photovoltaic array group and includes a curved surface configured to guide at least some of a wind, which blows from a back side of the photovoltaic array group toward the photovoltaic array group, to an upper side of the photovoltaic array group.

Concerning a photovoltaic power generation system, JIS (Japanese Industrial Standards) C8955 defines designing a solar panel assuming four kinds of loads: a dead load caused by the mass of a photovoltaic array itself, a wind pressure load caused by wind pressure, a snow load caused by snow accumulated on the surface of a solar panel, and a seismic load caused by a seismic force. The load combination changes depending on the installation environment. The wind pressure load is a load that needs to be taken into consideration in many solar power plants, and an approximation that calculates a wind pressure load applied to a photovoltaic array from a wind velocity is applied. When applying this standard, “in case there is a plurality of racks, a wind force coefficient calculated by the formula may be applied to the peripheral ends, and ½ the value may be applied to the central portion”. However there is no clear definition of what constitutes the central portion. For this reason, when designing a photovoltaic power generation system, it is important to appropriately estimate the region (central portion) where ½ the wind force coefficient at the peripheral ends is used so that safety can be ensured.

Embodiments will now be described with reference to the accompanying drawings. In the following embodiments, like reference numerals denote like elements, and a repetitive description thereof will be omitted.

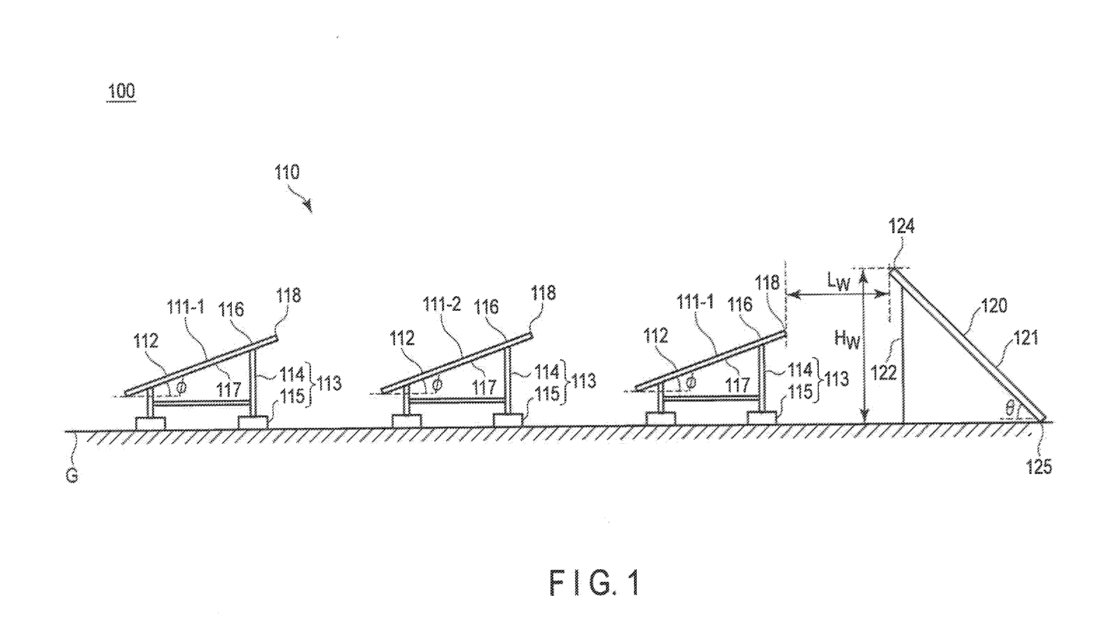

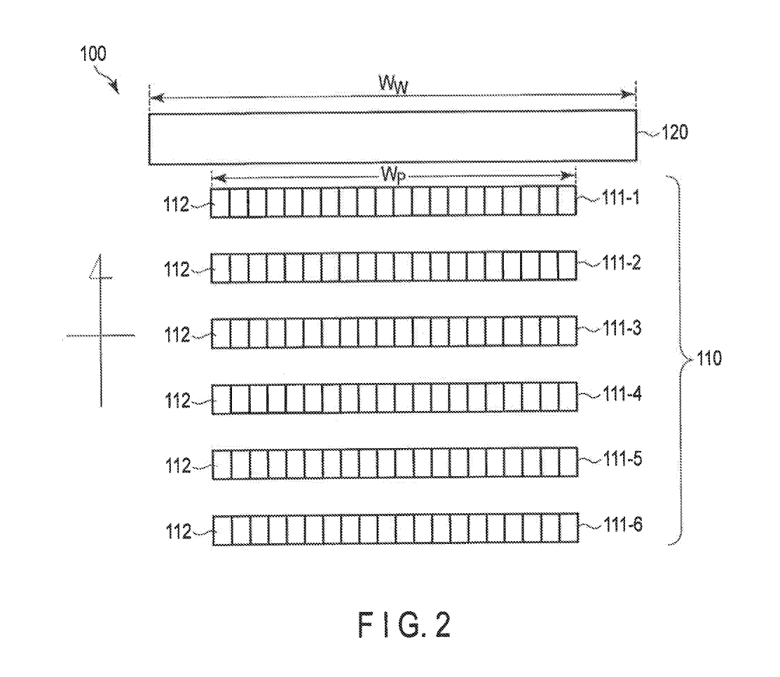

FIG. 1 is a side view schematically showing a photovoltaic power generation system 100 according to an embodiment. FIG. 2 is a plan view schematically showing the photovoltaic power generation system 100. As shown in FIG. 1, the photovoltaic power generation system 100 includes a photovoltaic array group 110 including a plurality of photovoltaic arrays 111, and a windbreak 120 arranged behind the photovoltaic array group 110. In the example shown in FIG. 2, six photovoltaic arrays 111-1 to 111-6 are juxtaposed. The photovoltaic arrays 111-4 to 111-6 are not illustrated in FIG. 1.

Each photovoltaic array 111 includes a plurality of solar panels 112 which receive sunlight and generate electric power, and a support structure 113 which supports and fixes the solar panels 112. The support structure 113 includes a rack 114 which supports the solar panels 112 tilting at a given angle from the level surface, and concrete bases 115 which fix the rack 114 on the ground G. Referring to FIG. 2, each rectangular block represents one solar panel 112. In the example of FIG. 2, 20 solar panels 112 connected by conductive connection members are arranged in each photovoltaic array 111.

In general, the solar panels 112 are installed in a tilted state from the viewpoint of power generation efficiency. For example, in regions at high latitudes in the Northern Hemisphere such as Japan, the solar panels 112 are installed while tilted so that their light receiving surfaces 116 face the south. An angle φ made by the level surface and the light receiving surface 116 is determined in consideration of various conditions such as the latitude and environment of the installation location.

In this embodiment, a case is assumed where the solar panels 112 are arranged southward. In this case, the six photovoltaic arrays 111-1 to 111-6 are juxtaposed in a north-south direction. In each of the photovoltaic arrays 111-1 to 111-6, the solar panels 112 are arrayed in an east-west direction. The windbreak 120 is arranged on the north side of the photovoltaic array group 110. Specifically, the windbreak 120 is arranged facing back surfaces 117 of the solar panels 112 of the northernmost photovoltaic array 111-1.

The windbreak 120 includes a baffle plate 121 which guides at least some of the wind, which blows from the back side of the photovoltaic array group 110 toward the photovoltaic array group 110 to the upper side of the photovoltaic array group 110, and a support structure 122 which supports the baffle plate 121 tilting at a given angle from the level surface. The back side of the photovoltaic array group 110 indicates the side facing the back surfaces 117 of the solar panels 112. In this embodiment in which the solar panels 112 are arranged southward, a wind which blows from the back side of the photovoltaic array group 110 toward the photovoltaic array group 110 indicates a wind including some wind flow from the north to the south, for example, a north wind, a northeastern wind, or a northwestern wind. In the example of FIG. 1, the baffle plate 121 is installed such that an upper edge 124 located at a position higher than an upper edge 118 of the solar panel 112, and a lower edge 125 is in contact with the ground G.

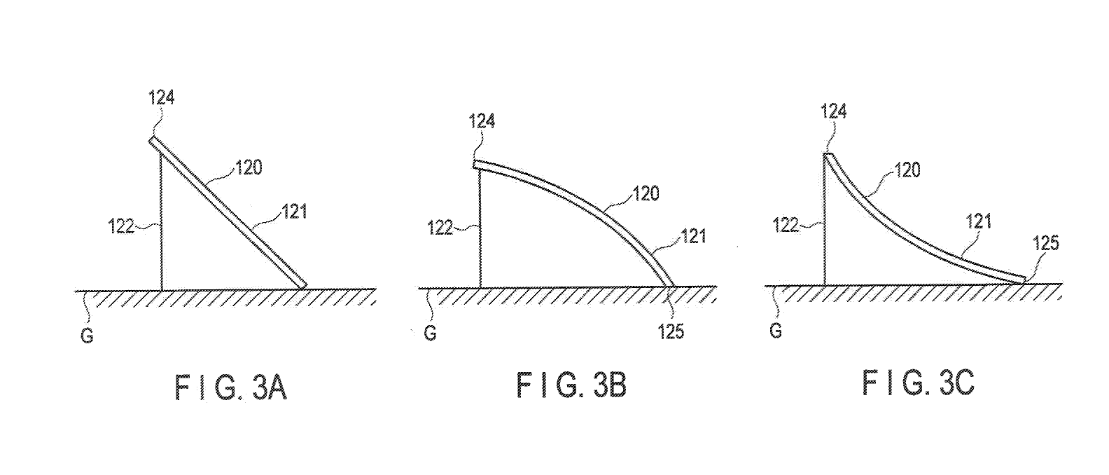

The baffle plate 121 may be formed into a planar shape (plate shape) as shown in FIG. 3A, a curved shape convex in a direction reverse to the side of the photovoltaic array group 110 as shown in FIG. 3E, or a curved shape convex toward the side of the photovoltaic array group 110 as shown in FIG. 3C. The baffle plate 121 can be formed from either one member or a plurality of members. Note that the windbreak 120 is not limited to the example shown in FIG. 1 in which it has a plate member such as the baffle plate 121. The windbreak 120 can be implemented by any structure having a surface (for example, flat or curved surface) that changes the flow of air so as to guide at least some of the wind, which blows from the back side of the photovoltaic array group 110 toward the photovoltaic array group 110, the upper side of the photovoltaic array group 110.

The windbreak 120 is arranged behind (that is, on the north side of) the northernmost photovoltaic array 111-1. As shown in FIG. 1, a distance Lw between the windbreak 120 and the northernmost photovoltaic array 111-1 is set within the range of, for example, 0 to 3 meters. A height Hw of the windbreak 120 is set within the range of, for example, 3 meters or less. An angle θ made by the level surface and the baffle plate 121 is set within the range of, for example, 45° to 60°. When the baffle plate 121 is formed into a curved shape, the angle θ indicates an angle made by the level surface and a line that connects the upper edge 124 and the lower edge 125 of the baffle plate 121. This arrangement prevents the solar panels 112 from falling in the shadow of the windbreak 120 and also prevents the power generation amount from decreasing due to a decrease in solar irradiation.

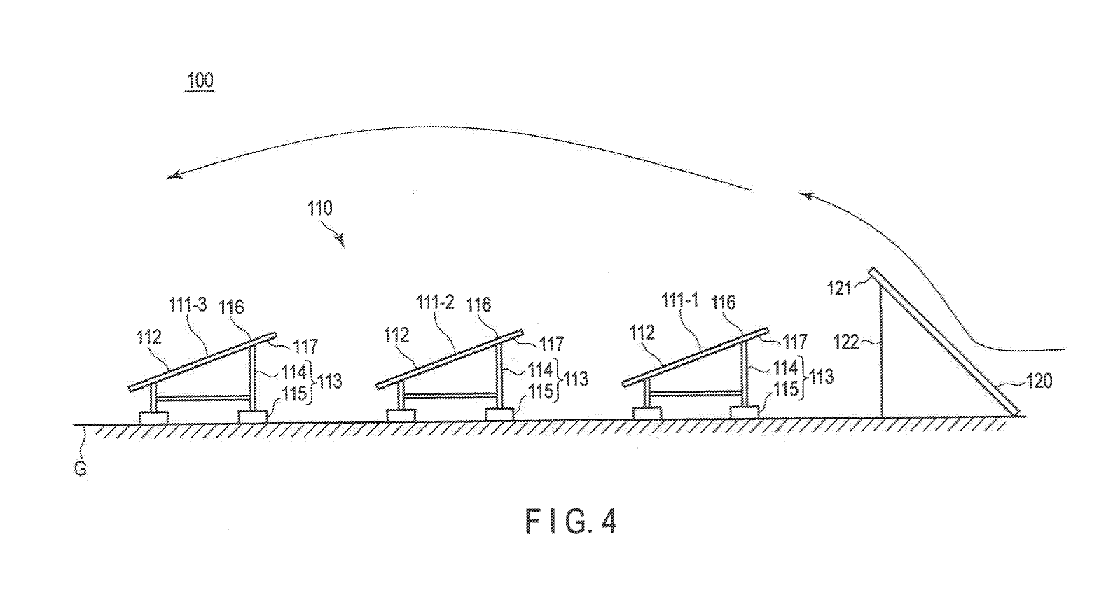

FIG. 4 schematically shows a state in which the flow of air is changed by the windbreak 120 when a north wind blows. If the windbreak 120 is not provided, some of the north wind blows toward the back surfaces 117 of the solar panels 112. This wind directly strikes the back surfaces 117 of the solar panels 112, and a high wind pressure (wind load) thus acts on the solar panels 112. In general, when the solar panels 112 are installed in a tilted state, the wind that blows from the back side of the photovoltaic array group 110 to the front side makes a higher wind pressure act on the solar panels 112 than a wind that blows from the front side of the photovoltaic array group 110 to the back side. For this reason, when designing the rack 114 and the base 115, their strengths are determined in consideration of the influence of the wind that blows from the back side toward the photovoltaic array group 110.

However, in this embodiment in which the windbreak 120 is provided, the wind travels along the baffle plate 121 of the windbreak 120, is lifted obliquely to the upper side, and passes above the photovoltaic array group 110, as indicated by the arrows in FIG. 4. That is, the windbreak 120 prevents at least some of the wind which blows from the back side toward the photovoltaic array group 110 from directly striking the back surfaces 117 of the solar panels 112. This reduces the wind that directly strikes the solar panels 112 and lowers the wind pressure acting on the solar panels 112. When the wind pressure acting on the solar panels 112 is reduced, the wind pressure resistance of the rack 114 and the base 115 can easily be ensured, and the rack 114 and the base 115 can be reduced for this reason. This makes it possible to implement cost reductions. To obtain a high windbreak effect, the upper edge 124 of the baffle plate 121 is preferably located at a position higher than the upper edge 116 of the solar panel 112, as shown in FIG. 1. In addition, a width Ww of the baffle plate 121 is preferably larger than a width Wp of the photovoltaic arrays 111, as shown in FIG. 2. In this embodiment, the widthwise direction corresponds to the east-west direction.

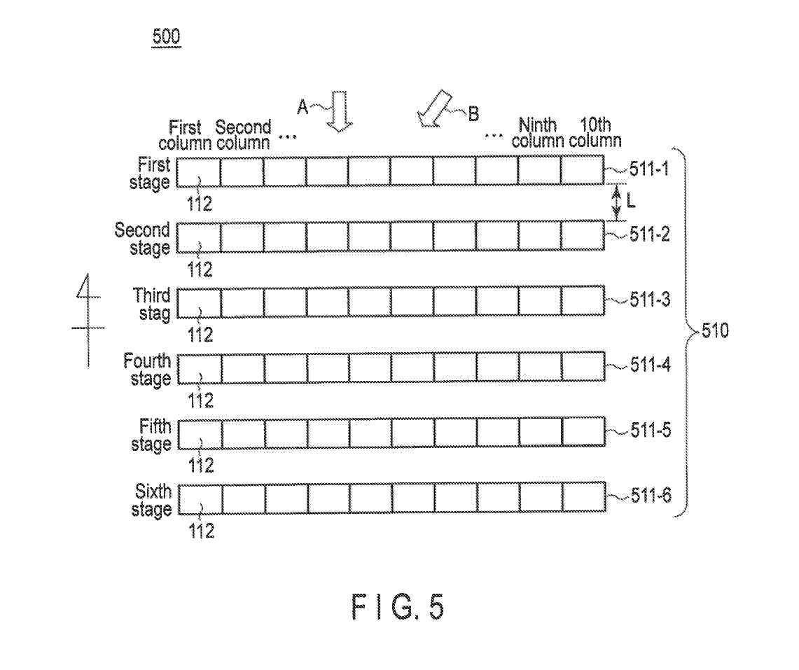

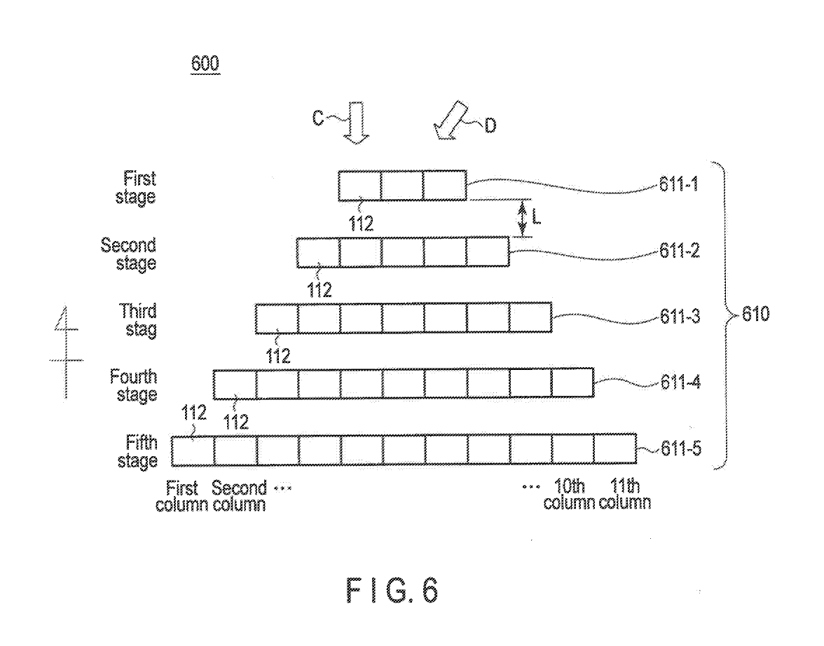

FIG. 5 schematically shows a photovoltaic power generation system 500 according to Comparative Example 1. FIG. 6 schematically shows a photovoltaic power generation system 600 according to Comparative Example 2. The photovoltaic power generation systems 500 and 600 shown in FIGS. 5 and 6 include no windbreak, unlike the photovoltaic power generation system 100 shown in FIG. 1. In a photovoltaic array group 510 of the photovoltaic power generation system 500, each of photovoltaic arrays 511 of six columns includes 10 solar panels 112. A photovoltaic array group 610 of the photovoltaic power generation system 600 shown in FIG. 6 includes photovoltaic arrays 611 of five columns, and the number of solar panels 112 changes between the photovoltaic arrays 611. A photovoltaic array 611-1 of the first column located at the northernmost end includes three solar panels 112, and a photovoltaic array 611-2 of the second column adjacent to the south side of the photovoltaic array 611-1 includes five solar panels 112. In this way, the number of solar panels 112 increases by two as the number of columns increases (that is, the position moves southward). In this case, a photovoltaic array 611-5 of the fifth column includes 11 solar panels 112.

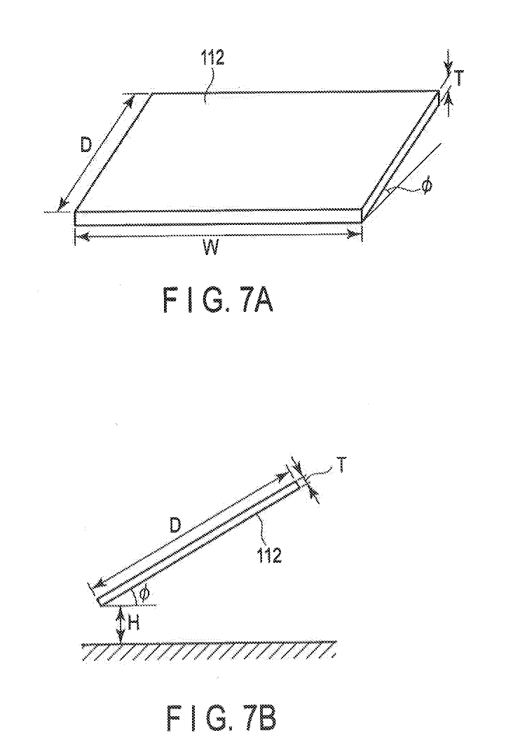

The present inventors obtained wind force coefficient distributions in the photovoltaic array groups 510 and 610 of the photovoltaic power generation systems 500 and 600 by numerical analysis. Analytic models used in the numerical analysis will be described. In the numerical analysis, elements (for example, a rack and a base) other than the solar panel 112 have little effect on the wind flow and are not taken into consideration. For the photovoltaic power generation system 500, as shown in FIG. 7A, a width W of the solar panel 112 is set to 1,500 mm, a depth D is set to 3,000 mm, and a thickness T is set to 100 mm. Additionally, as shown in FIG. 7B, a height H of the solar panel 112 is set to 500 mm, and the angle φ is set to 30°. As shown in FIG. 5, a distance L between the photovoltaic arrays 511 is set to 3,000 mm. The solar panels 112 are arranged southward. The wind directions are set to a direction from the north to the south (direction indicated by an arrow A in FIG. 5) and a direction from the northeast to the southwest (direction indicated by an arrow B in FIG. 5). The wind velocity is set to 30 m/s.

For the photovoltaic power generation system 600, the width W of the solar panel 112 is set to 1,500 mm, the depth D is set to 2,945 mm, and the thickness T is set to 100 mm. Additionally, the height H of the solar panel 112 is set to 730 mm, and the angle φ is set to 10°. As shown in FIG. 6, the distance L between the photovoltaic arrays 611 is set to 1,700 mm. The solar panels 112 are arranged southward. The wind directions are set to a direction from the north to the south (direction indicated by an arrow C in FIG. 6) and a direction from the northeast to the southwest (direction indicated by an arrow D in FIG. 6). The wind velocity is set to 30 m/s.

A wind force coefficient C is defined by equation (1) below. In equation (1), a direction from the back surfaces 117 of the solar panels 112 to the light receiving surfaces 116 is defined as positive concerning the wind force coefficient C. The wind force coefficient C represents that the larger the absolute value is, the higher the wind pressure acting on the solar panel 112 is.

$$C = \int \frac{{P}_{1} - {P}_{u}}{\frac{ρ {U}^{2} A}{2}} d A \qquad ( 1 )$$

Pₗ is the wind pressure acting on the back surface 117 of the solar panel 112, Pᵤ is the wind pressure acting on the light receiving surface 116 of the solar panel 112, ρ and U are the density and flow velocity of a fluid (air), respectively, and A is the area of the light receiving surface 116 or back surface 117 of the solar panel 112.

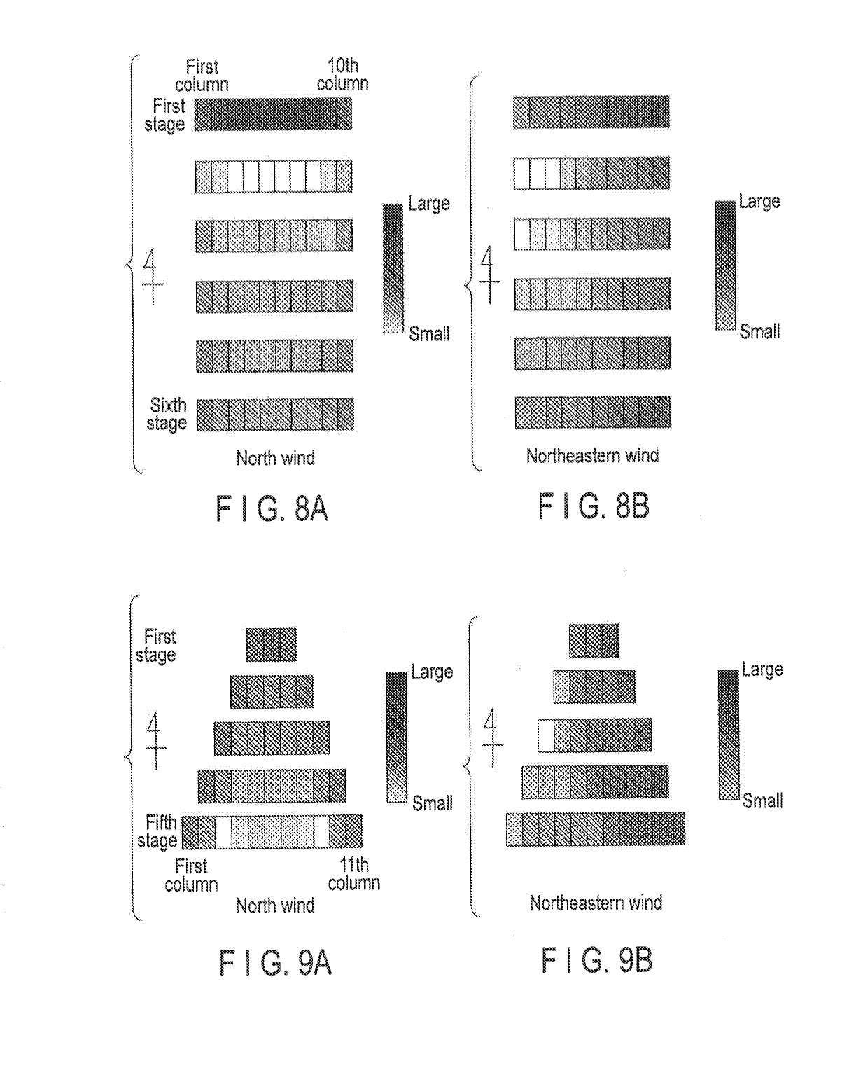

FIG. 8A shows a wind force coefficient distribution in the photovoltaic array group 510 obtained by numerical analysis in a case where the wind direction is the direction indicated by the arrow A in FIG. 5 (that is, a case where a north wind is assumed). FIG. SB shows a wind force coefficient distribution in the photovoltaic array group 510 obtained by numerical analysis in a case where the wind direction is the direction indicated by the arrow B in FIG. 5 (that is, a case where a northeastern wind is assumed), FIG. 9A shows a wind force coefficient distribution in the photovoltaic array group 610 obtained by numerical analysis in a case where the wind direction is the direction indicated by the arrow C in FIG. 6 (that is, a case where a north wind is assumed). FIG. 9B shows a wind force coefficient distribution in the photovoltaic array group 610 obtained by numerical analysis in a case where the wind direction is the direction indicated by the arrow D in FIG. 6 (that is, a case where a northeastern wind is assumed). Referring to FIGS. 8A, 8B, 9A, and 9B, the deeper the color is, the larger the value of the wind force coefficient is, and the lighter the color is, the smaller the value of the wind force coefficient is.

Referring to FIGS. 8A and 8B, the wind force coefficient tends to be larger for the solar panel 112 on the windward side in both the wind directions A and B. More specifically, in FIG. 8A, the wind force coefficients C are maximized in the photovoltaic array 511-1 of the first stage and minimized in the photovoltaic array 511-2 of the second stage. The wind force coefficients become large toward the photovoltaic arrays 511 on the leeward side. In the photovoltaic array 511-1 of the first stage on the windward side, the wind force coefficients are smaller for the solar panels 112 of the first, second, ninth, and 10th columns located at the ends as compared to the solar panels 112 of the third to eighth columns located at the center. In the photovoltaic arrays 511-2 to 511-6 of the second to sixth stages, the wind force coefficients are large for the solar panels 112 of the first and 10th columns located at the ends as compared to the solar panels 112 of the second to ninth columns located at the center. Referring to FIGS. 9A and 9B, the wind force coefficient tends to be larger for the solar panel 112 on the windward side in both the wind directions C and D. More specifically, in FIG. 9A, the wind force coefficients C are maximized in the photovoltaic array 611-1 of the first stage and become small toward the photovoltaic array 611 on the leeward side.

As described above, the tendency changes between the photovoltaic array group 510 and the photovoltaic array group 610. In the photovoltaic array group 510, a north wind swirls at the two ends and at the center of each photovoltaic array 511. In addition, a northeastern wind strikes the solar panel 112 at the east end (of the 10th column) of each photovoltaic array 511 and then flows through the photovoltaic arrays 511 while being disturbed. On the other hand, in the photovoltaic array group 610, a wind such as a northeastern wind from an oblique direction easily flows to the center region. The above-described difference in tendency probably occurs due to such a difference in the flow of air.

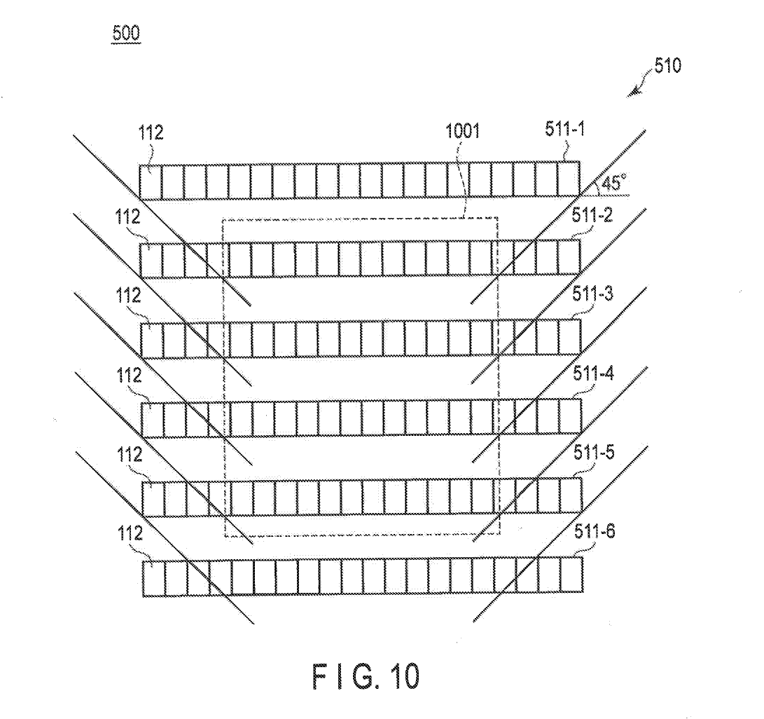

FIG. 10 shows an example of setting a region (central portion) 1001 to which a condition is applied in that ½ of the wind force coefficient at the peripheral ends is used when calculating the wind pressure load in the photovoltaic power generation system 500. This region will be referred to as a central region. In the example of FIG. 10, the central region 1001 is limited to a region located between two line segments passing through the two ends of the photovoltaic array 511 on the rear side (adjacent on the north side) and making an angle of 45° with respect to the photovoltaic array 511 in each of the photovoltaic arrays 511 of the second to fifth stages. In the central region 1001, the strength of the support structures can be, for example, half that of the support structures at the peripheral ends.

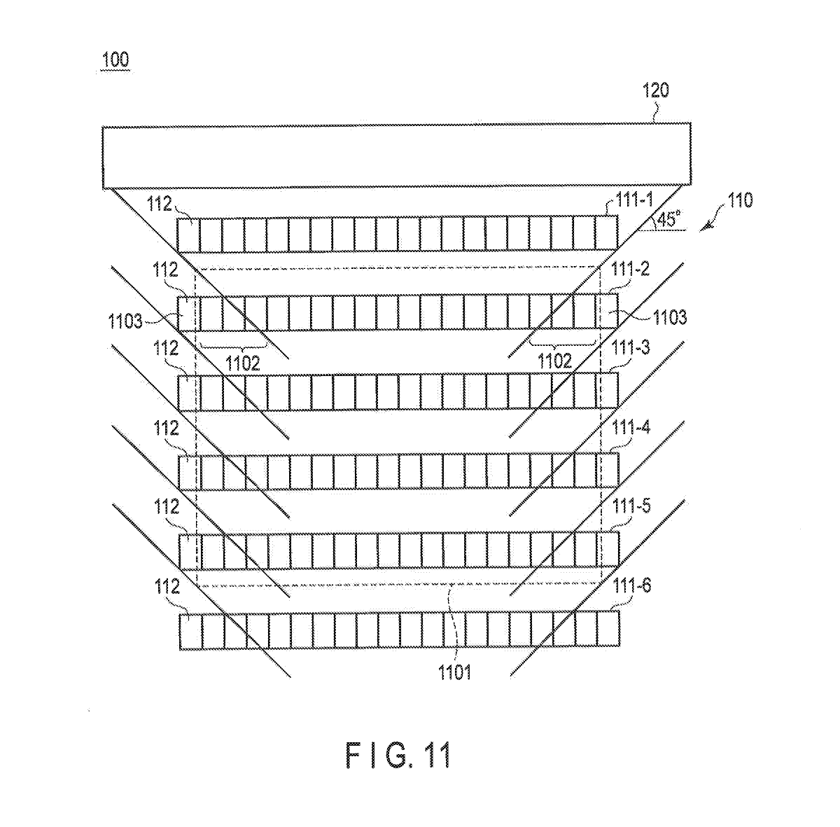

FIG. 11 shows an example of setting a central region 1101 in the photovoltaic power generation system 100 according to the embodiment. In this embodiment in which the windbreak 120 is provided, the central region 1101 can be set to a region excluding the peripheral ends of the photovoltaic array group 110, as shown in FIG. 11. In this embodiment, the windbreak 120 prevents the wind from directly striking the solar panels 112 at the peripheral ends of the photovoltaic array group 110. Since this lowers the wind pressure acting on the solar panels 112, the central region can be set wider. Specifically, the central region 1101 can be set wider in the photovoltaic arrays 111-2 to 111-5 other than the photovoltaic arrays 111 (specifically, the photovoltaic arrays 111-1 and 111-6) located on the front and back ends of the photovoltaic array group 110. For example, in the photovoltaic array 111-2, the strength of the support structure 113 in at least part of regions 1102 that exists outside two line segments passing through the two ends of the photovoltaic array 111-1 adjacent on the back side of the photovoltaic array 111-2 and making a 45° angle with respect to the photovoltaic array 111-1 and that excludes two ends 1103, can be half that of the support structure 113 at the two ends 1103 of the photovoltaic array 111-2. It is therefore possible to reduce the installation cost of the racks 114 and the bases 115.

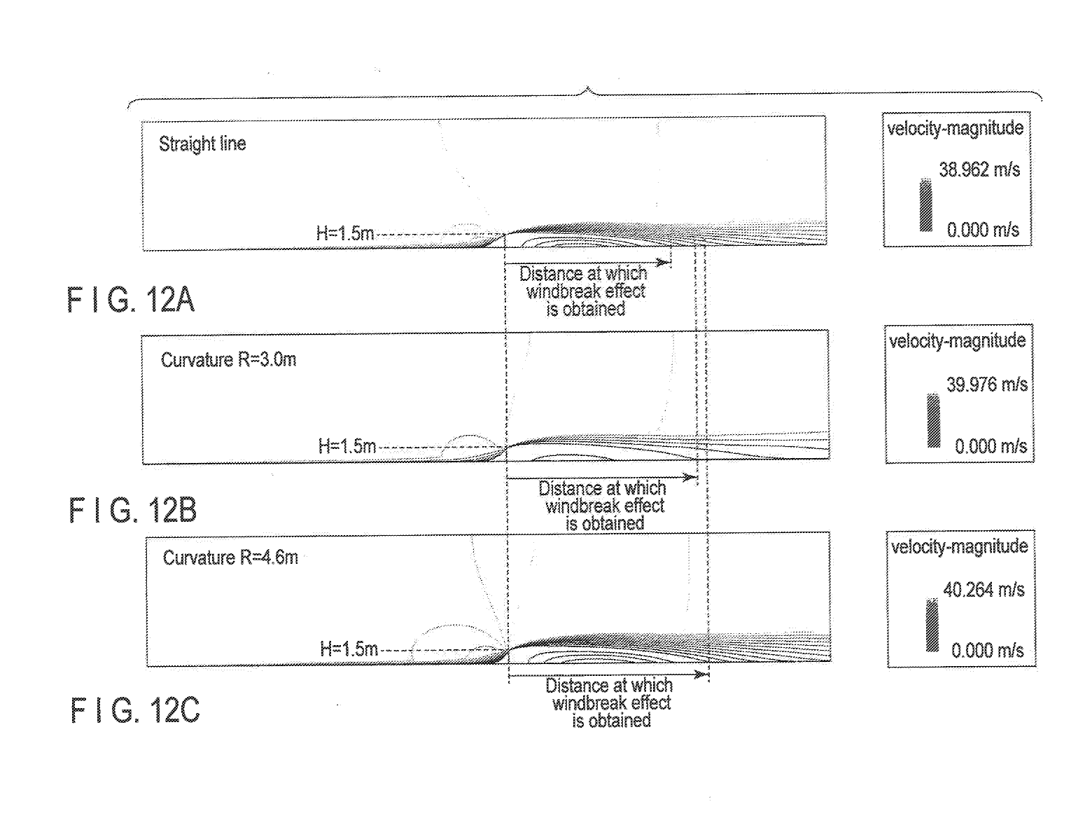

FIGS. 12A, 12B, and 12C show the results of two-dimensional analysis of a distance at which the windbreak effect of the windbreak 120 can be obtained.

FIG. 12A corresponds to a case where the baffle plate 121 is formed into a planar shape as shown in FIG. 3A.
FIGS. 12B and 12C correspond to a case where the baffle plate 121 is formed into a curved shape as shown in FIG. 3C. The curvature of a curve mimicking the windbreak 120 changes between FIGS. 12B and 12C. Referring to FIGS. 12A, 12B, and 12C, the deeper the color of a line is, the higher the wind velocity is, and the lighter the color is, the lower the wind velocity is. As can be understood from FIGS. 12A, 12B, and 12C, the distance at which the windbreak effect can be obtained is longer in the curved baffle plate 121 than in the flat baffle plate 121.

As described above, in the photovoltaic power generation system according to this embodiment, the windbreak is provided on the back side of the photovoltaic array group, thereby reducing the wind pressure acting on the back surfaces of the solar panels. This makes it possible to ensure safety and reduce the weight of the racks 114 and the bases 115. It is consequently possible to reduce the installation cost of the racks 114 and the bases 115.

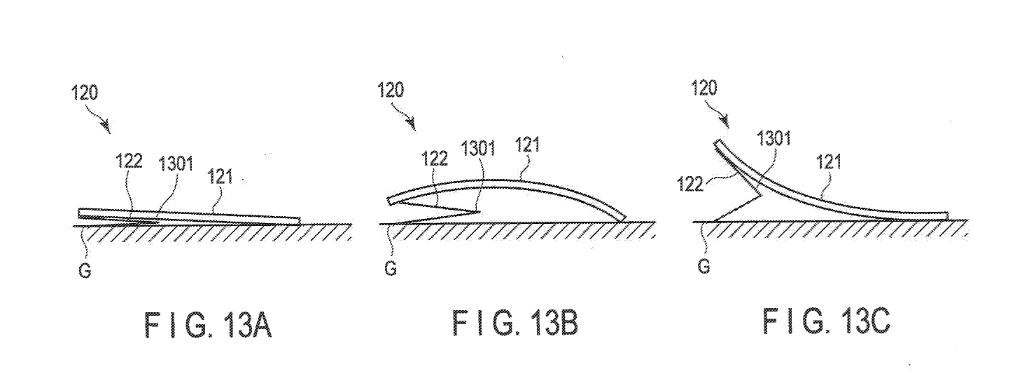

The support structure 122 of the windbreak 120 may include a tilting device which controls the tilt of the baffle plate 121. FIGS. 13A, 13B, and 13C show states which the baffle plates 121 having the shapes shown in FIGS. 3A, 3B, and 3C are tilted by a tilting device 1301 so as to make the angle θ small. In this embodiment, the solar panels 112 are arranged southward, and the windbreak 120 is arranged on the north side of the photovoltaic array group 110. In this case, when a strong south wind blows, the baffle plate 121 of the windbreak 120 receives a high wind pressure. When a strong south wind blows, the wind pressure acting on the baffle plate 121 can be reduced by making the angle θ of the baffle plate 121 small using the tilting device 1301. In addition, the windbreak may include a storage to store a maintenance tool to be used to maintain the photovoltaic power generation system 100.

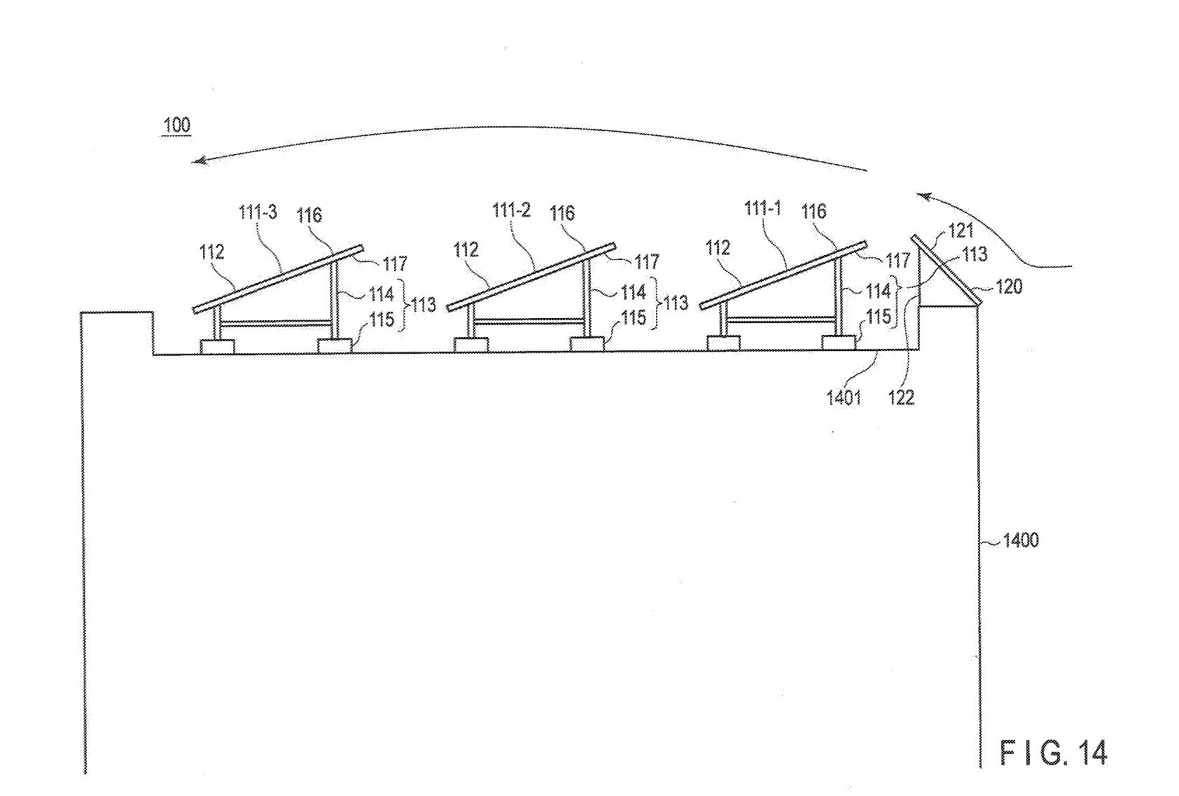

The photovoltaic power generation system 100 is not limited to the ground installation example. For example, the photovoltaic power generation system 130 may be installed on a flat roof 1401 of a building 1400, as shown in FIG. 14. In this case as well, the direction of wind that blows from the back side of the photovoltaic array group 110 is changed by the windbreak 120 and passes above the photovoltaic array group 110 as indicated by the arrows in FIG. 14. The wind can thus be prevented from directly striking the back surfaces 117 of the solar panels 112, and the wind pressure received by the solar panels 112 can be reduced. This makes it possible to ensure safety and reduce the weight of the racks 114 and the bases 115.

The arrangement of the photovoltaic array group 110 is not limited to the arrangement example shown in FIG. 1. For example, the photovoltaic array group 110 may change the width for each photovoltaic array 111, like the photovoltaic array group 610 shown in FIG. 6.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A photovoltaic power generation system comprising:
a photovoltaic array group including a plurality of photovoltaic arrays, each of the photovoltaic arrays including a plurality of solar panels and a support structure which supports the solar panels; and
a windbreak arranged behind the photovoltaic array group and including a curved surface configured to guide at least some of a wind, which blows from a back side of the photovoltaic array group toward the photovoltaic array group, to an upper side of the photovoltaic array group.

2. The system according to claim 1, wherein the windbreak comprises a baffle plate having the curved surface, and a support structure which supports the baffle plate so that a tilt of the baffle plate is changed.

3. The system according to claim 1, wherein in at least one of the photovoltaic arrays, except a photovoltaic array located on a front end of the photovoltaic array group and a photovoltaic array located on a back end of the photovoltaic array group, a strength of the support structure in at least part of regions which exist outside two line segments passing through two ends of the photovoltaic array adjacent on the back side of the at least one photovoltaic array and making an angle of 45° with respect to the photovoltaic array adjacent on the back side is half that of the support structure at two ends of the at least one photovoltaic array.

4. The system according to claim 1, wherein the windbreak comprises a storage to store a maintenance tool.
